(19) United States
(12) Patent Application Publication
(10) Pub. No.: US 2023/0170133 A1
(43) Pub. Date: Jun. 1, 2023

(54) COIL COMPONENT

(71) Applicant: SAMSUNG ELECTRO-MECHANICS CO., LTD., Suwon-si (KR)

(72) Inventors: Yu Jung Park, Suwon-si (KR); Jin Young Kim, Suwon-si (KR); Hyeon Jin Jang, Suwon-si (KR)

(73) Assignee: SAMSUNG ELECTRO-MECHANICS CO., LTD., Suwon-si (KR)

(21) Appl. No.: 17/978,652

(22) Filed: Nov. 1, 2022

(30) Foreign Application Priority Data
Nov. 30, 2021 (KR) 10-2021-0168415

(51) Int. Cl. H01F 27/29; H01F 27/32; H01F 41/04

(52) U.S. Cl. CPC H01F 27/29; H01F 27/323; H01F 41/04

(57) ABSTRACT

A coil component includes a body including a first surface and a plurality of side surfaces respectively connected to the first surface, a substrate disposed in the body, a coil portion disposed in the body, a lead-out portion disposed in the body and connected to the coil portion, and a dummy portion spaced apart from the lead-out portion. The body includes four corners, at each of which two adjacent side surfaces of the first to fourth side surfaces are in contact with each other, and the dummy portion includes first to fourth dummy patterns respectively disposed outside the coil portion and extending toward the four corners of the body.

### CROSS-REFERENCE TO RELATED APPLICATION(S)

This application claims the benefit of priority to Korean Patent Application No. 10-2021-0168415 filed on Nov. 30, 2021 in the Korean Intellectual Property Office, the disclosure of which is incorporated herein by reference in its entirety.

### TECHNICAL FIELD

The present disclosure relates to a coil component.

### BACKGROUND

An inductor, a coil component, is a representative passive electronic component used in an electronic device together with a resistor and a capacitor.

As the electronic device implements high-performance and has a smaller size, the electronic component used in the electronic device may have increased numbers and a smaller size.

In recent years, the inductor has been frequently deformed or damaged when mounted on a printed circuit board, and research is thus continued to solve this problem.

### SUMMARY

An aspect of the present disclosure may provide a coil component including a microcircuit pattern, which may be mounted on a board.

Another aspect of the present disclosure may provide a coil component including a coil with less deformation.

According to an aspect of the present disclosure, a coil component includes a body including a first surface and first to fourth side surfaces respectively connected to the first surface, a substrate disposed in the body, a coil portion disposed on the substrate, a lead-out portion disposed in the body and connected to the coil portion, and a dummy portion spaced apart from the lead-out portion, wherein the body includes four corners, at each of which two adjacent side surfaces of the first to fourth side surfaces are in contact with each other, and the dummy portion includes first to fourth dummy patterns respectively disposed outside the coil portion toward the four corners of the body.

According to another aspect of the present disclosure, a coil component includes a body, a substrate disposed in the body, a coil portion disposed on the substrate, a lead-out portion disposed in the body and connected to the coil portion, and a dummy portion disposed in the body and including first to fourth dummy patterns each being spaced apart from the coil portion.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a coil component according to one exemplary embodiment of the present disclosure;

FIG. 2 is a perspective view of a coil component according to another exemplary embodiment of the present disclosure;

FIG. 3 is a perspective view of a coil component according to still another exemplary embodiment of the present disclosure;

FIG. 4 is a cross-sectional view taken along line I-I′ of FIG. 1; and

FIG. 5 is a cross-sectional view taken along line II-II′ of FIG. 1.

### DETAILED DESCRIPTION

Hereinafter, exemplary embodiments in the present disclosure will now be described in detail with reference to the accompanying drawings.

In the drawings, a T direction refers to a first direction or a thickness direction, a W direction refers to a second direction or a width direction, and an L direction refers to a third direction or a length direction.

Hereinafter, a coil component according to exemplary embodiments of the present disclosure will be described in detail with reference to the accompanying drawings. In describing exemplary embodiments of the present disclosure with reference to the accompanying drawings, components that are the same as or correspond to each other will be denoted by the same reference numerals, and overlapping descriptions thereof will be omitted.

Various kinds of electronic components may be used in an electronic device, and various kinds of coil components may be appropriately used between these electronic components depending on their purposes in order to remove noise or the like.

That is, the coil component used in the electronic device may be a power inductor, high frequency (HF) inductor, a general bead, a bead for a high frequency (GHz), a common mode filter or the like.

### Coil Component

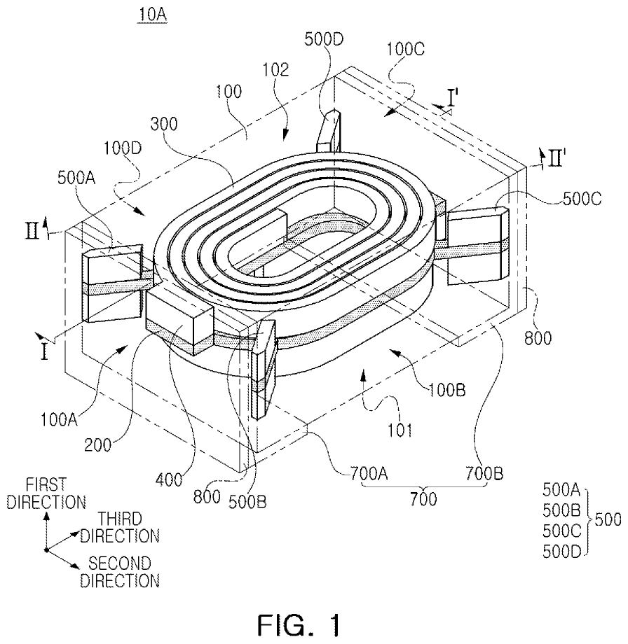

FIG. 1 is a perspective view of a coil component according to one exemplary embodiment of the present disclosure.

Referring to the drawing, a coil component 10A according to an exemplary embodiment of the present disclosure may include a body 100 including a first surface 101 and first to fourth side surfaces 100A, 100B, 100C and 100D respectively connected to the first surface 101 and adjacent to each other, a substrate 200 disposed in the body 100, a coil portion 300 disposed on the substrate 200, a lead-out portion 400 disposed in the body 100 and connected to the coil portion 300, and a dummy portion 500 spaced apart from the lead-out portion 400.

Here, the body 100 may include four corners, at each of which two adjacent side surfaces of the first to fourth side surfaces 100A, 100B, 100C and 100D are in contact with each other.

In addition, the dummy portion 500 may include first to fourth dummy patterns 500A, 500B, 500C and 500D respectively disposed outside the coil portion 300 and extending toward the four corners of the body 100.

In more detail, the first to fourth dummy patterns 500A, 500B, 500C and 500D of the dummy portion 500 may be disposed outside a plurality of turns of the coil portion 300, and may extend toward the four corners or vertices of the body 100. Here, each of the first to fourth dummy patterns 500A, 500B, 500C and 500D of the dummy portion 500 may extend in a diagonal direction toward a respective one of the four corners. That is, the first to fourth dummy patterns 500A, 500B, 500C and 500D of the dummy portion 500 may form an X-shape, based on a plan view or a top view of the coil component 10A according to the present disclosure, and are not limited thereto.

In addition, the substrate 200 of the coil component 10A according to the present disclosure may support each of the coil portion 300 and the dummy portion 500. Here, a region of the board, supporting the coil portion 300 and a region of the board, supporting the dummy portion 500, may be integrally formed with each other.

In addition, at least a portion of the lead-out portion 400 of the coil component 10A according to the present disclosure may be exposed to each of the first and third side surfaces 100A and 100C of the body 100, opposing each other. In addition, at least a portion of each of the first to fourth dummy patterns 500A, 500B, 500C and 500D of the dummy portion 500 maybe exposed to two adjacent surfaces of the first to fourth side surfaces 100A, 100B, 100C and 100D of the body 100, and is not limited thereto.

In addition, the dummy portion 500 of the coil component 10A according to the present disclosure may be spaced apart from the coil portion 300. Here, at least a portion of the substrate 200 may be exposed to a space where the dummy portion 500 and the coil portion 300 are spaced apart from each other.

The coil component 10A according to the present disclosure may further include an insulating layer 600 covering the coil portion 300. Here, the insulating layer 600 may integrally cover each of the coil portion 300, the substrate 200 and the dummy portion 500 in a process described below, and is not limited thereto.

Here, the insulating layer 600 may function to insulate the body 100 and the coil portion 300 from each other, and the coil portion 300 and the dummy portion 500 from each other, and is not limited thereto.

In addition, although not illustrated, the coil component 10A according to the present disclosure may include a via passing through the substrate 200 and connecting the upper and lower coil portions 300 to each other, and is not limited thereto.

In addition, at least a portion of the substrate 200 may be exposed to each of the first and third side surfaces 100A and 100C opposing each other among the first to fourth side surfaces 100A, 100B, 100C and 100D of the body 100, and is not limited thereto.

Here, at least a portion of the lead-out portion 400 disposed on the upper surface or the other surface of the substrate 200 may also be exposed to each of the first and third side surfaces 100A and 100C of the body 100.

The coil component 10A according to the present disclosure may further include an external electrode 700 having first and second external electrodes 700A and 700B disposed on the first surface 101 of the body 100, while being spaced apart from each other. Here, the external electrode 700 may be disposed on each of the first and third side surfaces 100A and 100C of the body 100, opposing each other, and in contact with at least a portion of the lead-out portion 400, and is not limited thereto.

Here, the external electrode 700 maybe in contact with the dummy portion 500, and is not limited thereto. An insulating material or a magnetic material of the body 100 may be disposed between the external electrode 700 and the dummy portion 500, and thus, these components may not be connected to each other.

It does not matter even if the dummy portion 500 is connected to the external electrode 700 because the dummy portion 500 is insulated from the coil portion 300 by the insulating layer 600 and no current thus flows therebetween. Alternatively, the external electrode 700 and the dummy portion 500 may be insulated from each other by disposing the insulating material on each of the first and third side surfaces 100A and 100C of the body 100 on which the external electrode 700 is formed.

In addition, the coil component 10A according to the present disclosure may further include an insulating portion 800 disposed on each of the first and third side surfaces 100A and 100C of the body 100, opposing each other, to cover at least a portion of the external electrode 700. This configuration may be an exemplary embodiment of the coil component 10A including a bottom electrode. Here, the external electrode 700 may be disposed only on the first surface 101 of the body 100 when viewed from the outside, and is not limited thereto.

In addition, the insulating portion 800 may cover five surfaces of the body 100 except for the first surface 101, thus forming the coil component 10A including the bottom electrode which is the electrode disposed in only one direction.

The body 100 may form an appearance of the coil component 10A according to this exemplary embodiment, and may embed the coil portion 300 therein. The body 100 may generally have a hexahedral shape.

The body 100 may include the magnetic material and an insulating resin. In more detail, the body 100 may be formed by stacking at least one magnetic composite sheet including the insulating resin and the magnetic materials dispersed in the insulating resin. However, the body 100 may have a structure other than a structure in which the magnetic materials are dispersed in the insulating resin. For example, the body 100 may be made of the magnetic material such as ferrite.

The magnetic material may be the ferrite or metal magnetic powder particles.

The ferrite powder particles may include, for example, at least one of a spinel type ferrite such as Mg—Zn-based ferrite, Mn—Zn-based ferrite, Mn—Mg-based ferrite, Cu—Zn-based ferrite, Mg—Mn—Sr-based ferrite or Ni—Zn-based ferrite, a hexagonal type ferrite such as Ba—Zn-based ferrite, Ba—Mg-based ferrite, Ba—Ni-based ferrite, Ba—Co-based ferrite or Ba—Ni—Co-based ferrite, and a garnet type ferrite such as Y-based ferrite or Li-based ferrite.

The metal magnetic powder particles may include one or more selected from the group consisting of iron (Fe), silicon (Si), chromium (Cr), cobalt (Co), molybdenum (Mo), aluminum (Al), niobium (Nb), copper (Cu) and nickel (Ni). For example, the metal magnetic powder particles may be one or more of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles and Fe—Cr—Al-based alloy powder particles.

The metal magnetic powder particles may be amorphous or crystalline. For example, the metal magnetic powder particles may be Fe—Si—B—Cr based amorphous alloy powder particles, and are not necessarily limited thereto.

The ferrite and the metal magnetic powder particles may have average diameters of about 0.1 μm to 30 μm, respectively, and are not limited thereto.

The body 100 may include two or more types of magnetic materials dispersed in the insulating resin. Here, different types of magnetic materials may indicate that the magnetic materials dispersed in the insulating resin are distinguished from each other by any one of an average diameter, a composition, crystallinity and a shape.

The insulating resin may include epoxy, polyimide, liquid crystal polymer (LCP) or the like, or a mixture thereof, and is not limited thereto.

The coil portion 300 and the lead-out portion 400 may each be embedded in the body 100. The coil portion 300 may exhibit a characteristic of the coil component 10A according to the present disclosure. For example, when the coil component of this exemplary embodiment is used as a power inductor, the coil portion 300 may serve to store an electric field as a magnetic field to maintain an output voltage, thereby stabilizing power of the electronic device. Here, the coil portion 300 may not be limited to a thin-film coil, and may be a wound-type coil or a stacked-type coil.

The dummy portion 500 may also be embedded in the body 100. The dummy portions 500 may be disposed at the corners of the body 100, and form the X-shape.

In particular, the dummy portion 500 may have a width of 10 μm to 500 μm, and is not limited thereto. The dummy portion 500 having a width of less than 10 μm may not function as a stopper when plated. The dummy portion 500 having a width of more than 500 μm may make the coil component have an excessively large size, and it is thus difficult to manufacture a thin/small coil component.

The following is a method of measuring the width of the dummy portion 500.

First taken is a cross section of any point of the dummy portion 500. Here, any point may correspond to a plurality of any points, and is not limited thereto.

Next, based on the cross section of the dummy portion 500, a length of the dummy portion in the first direction, that is, in a direction other than the thickness direction (hereinafter referred to as width of the dummy portion), may be measured several times. Here, the width of the dummy portion 500 may correspond to an arithmetic average of measured values obtained from the several measurements.

A thin film power inductor may be deformed when a magnetic layer is stacked on a printed circuit board and then compressed. Here, the printed circuit board may have an increased region for supporting the coil, which may be advantageous in the deformation and exposure of the coil, and is not limited thereto.

It is possible to make the coil component smaller and thinner and reduce a cut margin by minimizing the deformation or loss of the coil. It is thus possible to improve a characteristic of a coreless printed circuit board and a saturated current value (Isat) characteristic of the power inductor.

Each of the coil portion 300, lead-out portion 400, dummy portion 500 and the via may be formed of a conductive material such as copper (Cu), aluminum (Al), silver (Ag), tin (Sn), gold (Au), nickel (Ni), lead (Pb), titanium (Ti) or an alloy thereof, and is not limited thereto.

In addition, the substrate 200 of the coil component 10A according to the present disclosure may be formed of an insulating material including a thermosetting insulating resin such as an epoxy resin, a thermoplastic insulating resin such as polyimide or a photosensitive insulating resin, or an insulating material impregnated with a reinforcing material such as a glass fiber or inorganic filler in the insulating resin. For example, the substrate 200 may be formed of the insulating material such as a copper clad laminate (CCL), an unclad CCL, prepreg, an Ajinomoto build-up film (ABF), FR-4, a bismaleimide triazine (BT) film or a photo imagable dielectric (PID), and is not limited thereto.

In particular, the inorganic filler may be a material of the substrate 200 of the coil component 10A according to the present disclosure and use one or more materials selected from the group consisting of silica (or silicon dioxide, SiO₂), alumina (or aluminum oxide, Al₂O₃), silicon carbide (SiC), barium sulfate (BaSO₄), talc, clay, mica powder particles, aluminum hydroxide (AlOH₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃).

Here, when formed of the insulating material including the reinforcing material, the substrate 200 may have more excellent rigidity. The substrate 200 may be formed of the insulating material not including the glass fiber, which may be advantageous because the coil portion 300 may have an increased volume in the body 100 having the same size.

In addition, when the substrate 200 is formed of the insulating material including the photosensitive insulating resin, it is possible to reduce the number of processes of forming the coil portion 300, which may be advantageous in reducing a production cost, and forming a fine via.

A metal included in the external electrode 700 having the first and second external electrodes 700A and 700B may each be made of an alloy of two or more selected from the group consisting of tin (Sn), lead (Pb), indium (In), copper (Cu), silver (Ag) and bismuth (Bi).

The external electrode 700 may be formed by applying a conductive resin paste or may be formed by plating a material including the metal material, and is not limited thereto.

The insulating layer 600 surrounding the coil portion 300 may be formed by using at least one of a vapor deposition method and a film lamination method. Meanwhile, the insulating layer 600 formed by using the latter method may be a permanent resist in which a plating resist used in plating the coil portion 300 on the substrate 200 remains in a final product, and is not limited thereto.

In addition, the external electrode 700 may further include a plating layer. Here, the plating layer may include the conductive material. The plating layer may be electrically connected to a solder, which is a connecting conductor. Here, the plating layer may include nickel (Ni) or tin (Sn), and may have a structure in which a nickel (Ni) plating layer and a tin (Sn) plating layer are sequentially stacked. When the external electrode is a conductive resin layer, the nickel (Ni) plating layer may be in contact with the conductive connection portion and base resin of the conductive resin layer in the external electrode 700.

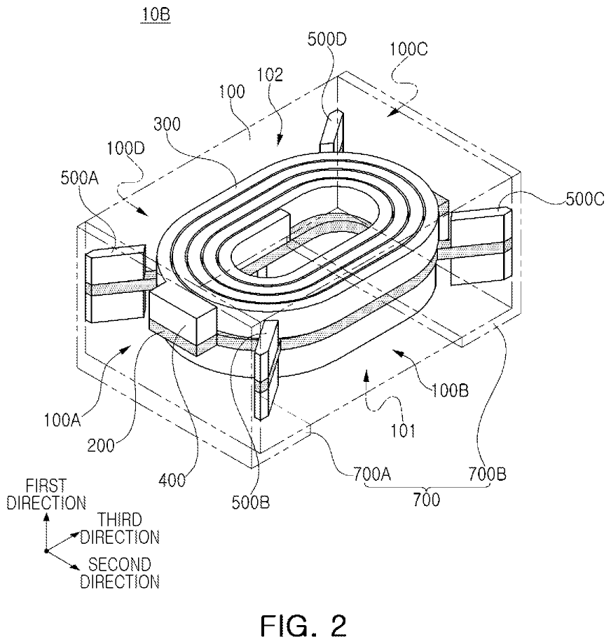

FIG. 2 is a perspective view of a coil component 10B according to another exemplary embodiment of the present disclosure.

Referring to the drawing, the coil component 10B according to an exemplary embodiment of the present disclosure may include a body 100 including a first surface 101 and first to fourth side surfaces 100A, 100B, 100C and 100D respectively connected to the first surface 101 and adjacent to each other, a substrate 200 disposed in the body 100, a coil portion 300 disposed on the substrate 200, a lead-out portion 400 disposed in the body 100 and connected to the coil portion 300, and a dummy portion 500 spaced apart from the lead-out portion 400.

Here, the body 100 may include four corners, at each of which two adjacent side surfaces of the first to fourth side surfaces 100A, 100B, 100C and 100D are in contact with each other.

In addition, the dummy portion 500 may include first to fourth dummy patterns 500A, 500B, 500C and 500D respectively disposed outside the coil portion 300 and extending toward the four corners of the body 100.

In more detail, the first to fourth dummy patterns 500A, 500B, 500C and 500D of the dummy portion 500 may be disposed outside a plurality of turns of the coil portion 300, and may extend toward the four corners or vertices of the body 100. That is, the first to fourth dummy patterns 500A, 500B, 500C and 500D of the dummy portion 500 may form an X-shape, based on a plan view or a top view of the coil component 10B according to the present disclosure, and are not limited thereto.

The dummy portion 500 may also be embedded in the body 100. The dummy portions 500 may be disposed at the corners of the body 100, and form the X-shape.

In particular, the dummy portion 500 may have a width of 10 μm to 500 μm, and is not limited thereto. The dummy portion 500 having a width of less than 10 um may not function as a stopper when plated. The dummy portion 500 having a width of more than 500 μm may make the coil component have an excessively large size, and it is thus difficult to manufacture a thin/small coil component.

The following is a method of measuring the width of the dummy portion 500.

First taken is a cross section of any point of the dummy portion 500. Here, any point may correspond to a plurality of any points, and is not limited thereto.

Next, based on the cross section of the dummy portion 500, a length of the dummy portion in the first direction, that is, in a direction other than the thickness direction (hereinafter referred to as width of the dummy portion), may be measured several times. Here, the width of the dummy portion 500 may correspond to an arithmetic average of measured values obtained from the several measurements.

A thin film power inductor may be deformed when a magnetic layer is stacked on a printed circuit board and then compressed. Here, the printed circuit board may have an increased region for supporting the coil, which may be advantageous in the deformation and exposure of the coil, and is not limited thereto.

It is possible to make the coil component smaller and thinner and reduce a cut margin by minimizing the deformation or loss of the coil. It is thus possible to improve a characteristic of a coreless printed circuit board and a saturated current value (Isat) characteristic of the power inductor.

In addition, the substrate 200 of the coil component 10B according to the present disclosure may support each of the coil portion 300 and the dummy portion 500. Here, a region of the substrate, supporting the coil portion 300 and a region of the substrate, supporting the dummy portion 500, may be integrally formed with each other.

In addition, at least a portion of the lead-out portion 400 of the coil component 10B according to the present disclosure may be exposed to each of the first and third side surfaces 100A and 100C of the body 100, opposing each other. In addition, at least a portion of each of the first to fourth dummy patterns 500A, 500B, 500C and 500D of the dummy portion 500 may be exposed to two adjacent ones of the first to fourth side surfaces 100A, 100B, 100C and 100D of the body 100, and is not limited thereto.

In addition, the dummy portion 500 of the coil component 10B according to the present disclosure may be spaced apart from the coil portion 300. Here, at least a portion of the substrate 200 may be exposed to a space where the dummy portion 500 and the coil portion 300 are spaced apart from each other.

The coil component 10B according to the present disclosure may further include an insulating layer 600 covering the coil portion 500. Here, the insulating layer 600 may integrally cover each of the coil portion 300, the substrate 200 and the dummy portion 500 in a process described below, and is not limited thereto.

Here, the insulating layer 600 may function to insulate the body 100 and the coil portion 300 from each other, and the coil portion 300 and the dummy portion 500 from each other, and is not limited thereto.

In addition, although not illustrated, the coil component 10B according to the present disclosure may include a via passing through the substrate 200 and connecting the upper and lower coil portions 300 to each other, and is not limited thereto.

In addition, at least a portion of the substrate 200 may be exposed to each of the first and third side surfaces 100A and 100C opposing each other among the first to fourth side surfaces 100A, 100B, 100C and 100D of the body 100, and is not limited thereto.

Here, at least a portion of the lead-out portion 400 disposed on the upper surface or the other surface of the substrate 200 may also be exposed to each of the first and third side surfaces 100A and 100C of the body 100.

The coil component 10B according to the present disclosure may further include an external electrode 700 having first and second external electrodes 700A and 700B disposed on the first surface 101 of the body 100, while being spaced apart from each other. Here, the external electrode 700 may be disposed on each of the first and third side surfaces 100A and 100C of the body 100, opposing each other, and in contact with at least a portion of the lead-out portion 400, and is not limited thereto.

Here, the external electrode 700 may be in contact with the dummy portion 500, and is not limited thereto. The external electrode 700 and at least a portion of the dummy portion 500 may be in contact with each other.

It does not matter even if the dummy portion 500 is connected to the external electrode 700 because the dummy portion 500 is insulated from the coil portion 300 by the insulating layer 600 and no current thus flows therebetween. Alternatively, the external electrode 700 and the dummy portion 500 may be insulated from each other by disposing the insulating material on each of the first and third side surfaces 100A and 100C of the body 100 on which the external electrode 700 is formed.

In addition, unlike the coil component 10A of FIG. 1, in the coil component 10B according to the present disclosure, the external electrode 700 disposed on the first and third side surfaces 100A and 100C of the body 100, opposing each other, may be externally exposed. That is, when viewed from the outside, the coil component 10B according to the present disclosure may include the external electrode 700 having L-shaped first and second external electrodes 700A and 700B to each cover a portion of the first surface 101 of the body 100.

Descriptions of the other components are substantially the same as those described above, and detailed descriptions thereof are thus omitted.

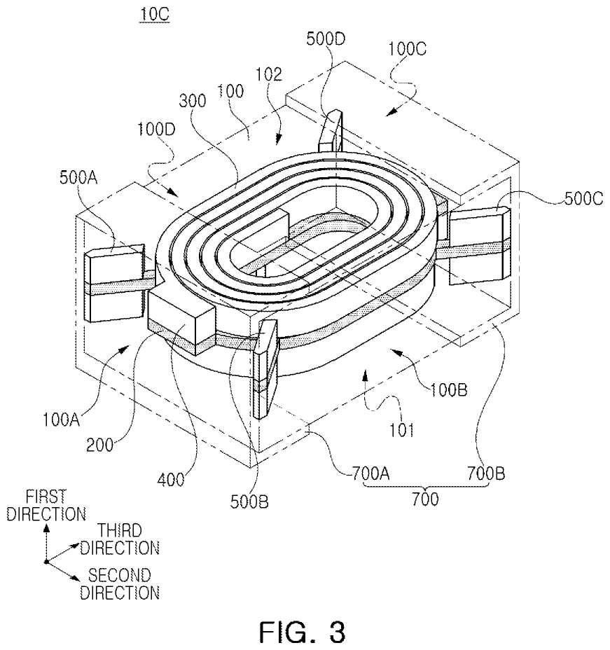

FIG. 3 is a perspective view of a coil component according to still another exemplary embodiment of the present disclosure.

Referring to the drawing, the coil component 10C according to an exemplary embodiment of the present disclosure may include: the body 100 including the first surface 101 and the first to fourth side surfaces 100A, 100B, 100C and 100D respectively connected to the first surface 101 and adjacent to each other, the substrate 200 disposed in the body 100, the coil portion 300 disposed on the substrate 200, the lead-out portion 400 disposed in the body 100 and connected to the coil portion 300, and the dummy portion 500 spaced apart from the lead-out portion 400.

Here, the body 100 may include four corners, at each of which two adjacent side surfaces of the first to fourth side surfaces 100A, 100B, 100C and 100D are in contact with each other.

In addition, the dummy portion 500 may include first to fourth dummy patterns 500A, 500B, 500C and 500D respectively disposed outside the coil portion 300 and extending toward the four corners of the body 100.

In more detail, the first to fourth dummy patterns 500A, 500B, 500C and 500D of the dummy portion 500 may be disposed outside a plurality of turns of the coil portion 300, and may extend toward the four corners or vertices of the body 100. That is, the first to fourth dummy patterns 500A, 500B, 500C and 500D of the dummy portion 500 may form an X-shape, based on a plan view or a top view of the coil component 10C according to the present disclosure, and are not limited thereto.

The dummy portion 500 may also be embedded in the body 100. The dummy portions 500 may be disposed at the corners of the body 100, and form the X-shape.

In particular, the dummy portion 500 may have a width of 10 μm to 500 μm, and is not limited thereto. The dummy portion 500 having a width of less than 10 μm may not function as a stopper when plated. The dummy portion 500 having a width of more than 500 μm may make the coil component have an excessively large size, and it is thus difficult to manufacture a thin/small coil component.

The following is a method of measuring the width of the dummy portion 500.

First taken is a cross section of any point of the dummy portion 500. Here, any point may correspond to a plurality of any points, and is not limited thereto.

Next, based on the cross section of the dummy portion 500, a length of the dummy portion in the first direction, that is, in a direction other than the thickness direction (hereinafter referred to as width of the dummy portion), may be measured several times. Here, the width of the dummy portion 500 may correspond to an arithmetic average of measured values obtained from the several measurements.

A thin film power inductor may be deformed when a magnetic layer is stacked on a printed circuit board and then compressed. Here, the printed circuit board may have an increased region for supporting the coil, which may be advantageous in the deformation and exposure of the coil, and is not limited thereto.

It is possible to make the coil component smaller and thinner and reduce a cut margin by minimizing the deformation or loss of the coil. It is thus possible to improve a characteristic of a coreless printed circuit board and a saturated current value (Isat) characteristic of the power inductor.

In addition, the substrate 200 of the coil component 10C according to the present disclosure may support each of the coil portion 300 and the dummy portion 500. Here, a region of the substrate 200, supporting the coil portion 300 and a region of the substrate 200, supporting the dummy portion 500, may be integrally formed with each other.

In addition, at least a portion of the lead-out portion 400 of the coil component 10C according to the present disclosure may be exposed to the first and third side surfaces 100A and 100C of the body 100, opposing each other. In addition, at least a portion of each of the first to fourth dummy patterns 500A, 500B, 500C and 500D of the dummy portion 500 may be exposed to two adjacent ones of the first to fourth side surfaces 100A, 100B, 100C and 100D of the body 100, and is not limited thereto.

In addition, the dummy portion 500 of the coil component 10C according to the present disclosure may be spaced apart from the coil portion 300. Here, at least a portion of the substrate 200 may be exposed to a space where the dummy portion 500 and the coil portion 300 are spaced apart from each other.

The coil component 10C according to the present disclosure may further include an insulating layer 600 covering the coil portion 300. Here, the insulating layer 600 may integrally cover each of the coil portion 300, the substrate 200 and the dummy portion 500 in a process described below, and is not limited thereto.

Here, the insulating layer 600 may function to insulate the body 100 and the coil portion 300 from each other, and the coil portion 300 and the dummy portion 500 from each other, and is not limited thereto.

In addition, although not illustrated, the coil component 10C according to the present disclosure may include a via passing through the substrate 200 and connecting the upper and lower coil portions 300 to each other, and is not limited thereto.

In addition, at least a portion of the substrate 200 may be exposed to each of the first and third side surfaces 100A and 100C opposing each other among the first to fourth side surfaces 100A, 100B, 100C and 100D of the body 100, and is not limited thereto.

Here, at least a portion of the lead-out portion 400 disposed on the upper surface or the other surface of the substrate 200 may also be exposed to each of the first and third side surfaces 100A and 100C of the body 100.

The coil component 10C according to the present disclosure may further include an external electrode 700 having first and second external electrodes 700A and 700B disposed on the first surface 101 of the body 100, while being spaced apart from each other. Here, the external electrode 700 may be disposed on each of the first and third side surfaces 100A and 100C of the body 100, opposing each other, and in contact with at least a portion of the lead-out portion 400, and is not limited thereto.

Here, the external electrode 700 may be in contact with the dummy portion 500, and is not limited thereto. The external electrode 700 and at least a portion of the dummy portion 500 may be in contact with each other.

It does not matter even if the dummy portion 500 is connected to the external electrode 700 because the dummy portion 500 is insulated from the coil portion 300 by the insulating layer 600 and no current thus flows therebetween. Alternatively, the external electrode 700 and the dummy portion 500 may be insulated from each other by disposing the insulating material on each of the first and third side surfaces 100A and 100C of the body 100 on which the external electrode 700 is formed.

In addition, the external electrodes 700 of the coil component 10C according to the present disclosure may further extend from the first and third side surfaces 100A and 100C of the body 100, opposing each other, onto a second surface 102 of the body 100, opposing the first surface 101. That is, when viewed from the outside, the external electrode 700 may be disposed on each of the first and third side surfaces 100A and 100C of the body 100 to extend to the first surface 101 of the body 100 and the second surface 102 opposing the first surface 101, and is not limited thereto.

Descriptions of the other components are substantially the same as those described above, and detailed descriptions thereof are thus omitted.

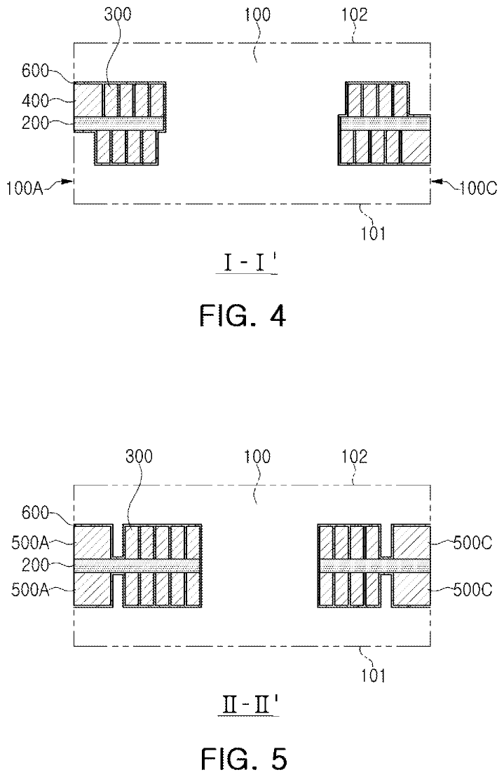

FIG. 4 is a cross-sectional view taken along line I-I′ of the component 10A shown in FIG. 1.

Referring to the drawing, the coil component 10A may be cut so that the first and third side surfaces 100A and 100C of the body 100, opposing each other, are respectively disposed on left and right sides. Here, a cut surface may pass through the lead-out portion 400.

Referring to FIG. 4, at least a portion of each of the substrate 200 and the lead-out portion 400 may be exposed to the first and third side surfaces 100A and 100C of the body 100.

In addition, at least a portion of the insulating layer 600 covering the coil portion 300 may also be exposed to each of the first and third side surfaces 100A and 100C of the body 100, and is not limited thereto.

In addition, although not illustrated in the drawings, the external electrode 700 having the first and second external electrodes 700A and 700B disposed on the first surface 101 of the body 100, while being spaced apart from each other, may be further disposed on the first and third side surfaces 100A and 100C of the body 100, opposing each other.

Here, the external electrode 700 may be disposed on each of the first and third side surfaces 100A and 100C of the body 100, opposing each other, and in contact with at least a portion of the lead-out portion 400, and is not limited thereto.

In addition, the external electrode 700 may be in contact with the dummy portion 500, and is not limited thereto. The external electrode 700 and at least a portion of the dummy portion 500 may be in contact with each other.

In addition, the coil component according to the present disclosure may further include the insulating portion 800 disposed on each of the first and third side surfaces 100A and 100C of the body 100, opposing each other, to cover at least a portion of the external electrode 700. This configuration may be an exemplary embodiment of the coil component 10A including a bottom electrode. Here, the external electrode 700 may be disposed only on the first surface 101 of the body 100 when viewed from the outside, and is not limited thereto. That is, the external electrode 700 disposed on the first and third side surfaces 100A and 100C of the body 100, opposing each other, may not be visible from the outside due to the insulating portion 800 disposed on each of the first and third side surfaces 100A and 100C of the body 100, opposing each other.

In addition, the insulating portion 800 may extend to the five surfaces of the body 100 except for the first surface 101, thus forming the coil component 10A including the bottom electrode which is the electrode disposed in only one direction.

Descriptions of the other components are substantially the same as those described above, and detailed descriptions thereof are thus omitted.

FIG. 5 is a cross-sectional view taken along line II-II′ of FIG. 1.

Here, a cut surface may pass through the dummy portion 500 to expose the dummy portion 500 disposed at the corner of the body 100.

Here, the dummy portion through which the cut surface passes may correspond to each of the first and third dummy patterns 500A and 500C opposing each other as shown in

FIG. 5, and is not limited thereto. The cut surface may pass through each of the second and fourth dummy patterns 500B and 500D opposing each other.

Referring to FIG. 5, at least portions of the substrate 200 and the dummy portion 500 may respectively be exposed to two corners of the body 100, opposing each other.

In addition, at least a portion of the insulating layer 600 covering the coil portion 300 may also be exposed to each of the first and third side surfaces 100A and 100C of the body, and is not limited thereto.

In addition, the substrate 200 of the coil component 10A according to the present disclosure may support each of the coil portion 300 and the dummy portion 500. Here, the region of the substrate 200, supporting the coil portion 300 and the region of the substrate 200, supporting the dummy portion 500, may be integrally formed with each other.

In addition, the dummy portion 500 of the coil component 10A according to the present disclosure may be spaced apart from the coil portion 300. Here, at least a portion of the substrate 200 may be exposed to the space where the dummy portion 500 and the coil portion 300 are spaced apart from each other.

In addition, although not illustrated in the drawings, the coil component according to the present disclosure may further include the external electrode 700 having the first and second external electrodes 700A and 700B disposed on the first surface 101 of the body 100, while being spaced apart from each other.

Here, the external electrode 700 may be in contact with the dummy portion 500, and is not limited thereto. The insulating material or the magnetic material of the body 100 maybe disposed between the external electrode 700 and the dummy portion 500, and thus, these components may not be connected to each other.

It does not matter even if the dummy portion 500 is connected to the external electrode 700 because the dummy portion 500 is insulated from the coil portion 300 by the insulating layer 600 and no current thus flows therebetween. Alternatively, the external electrode 700 and the dummy portion 500 may be insulated from each other by disposing the insulating material on each of the first and third side surfaces 100A and 100C of the body 100 on which the external electrode 700 is formed.

Descriptions of the other components are substantially the same as those described above, and detailed descriptions thereof are thus omitted.

### Manufacturing Method of Coil Component

The following is a manufacturing method of a coil component 10A, 10B or 10C according to the present disclosure.

First prepared is a substrate 200 on which a coil bar is to be formed.

The substrate 200 may not be particularly limited, maybe formed of at least one of a copper clad laminate, a prepreg (PPG), an Ajinomoto build-up film (ABF) and a photo imageable dielectric (PID) for example, may have a thickness of 20 to 100 μm, and is not limited thereto.

Here, a photosensitive material may be disposed on each region of both surfaces of the substrate 200 except for its regions where a dummy portion 500, a coil portion 300 and a lead-out portion 400 are respectively formed. Here, the photosensitive material may be disposed between the coil portion 300 and the dummy portion 500 so that the dummy portion 500 and the coil portion 300 are spaced apart from each other.

That is, the photosensitive material may be disposed in a space where the coil portion 300 and the dummy portion 500 are spaced apart from each other.

Next, each of the coil portion 300, the lead-out portion 400 and the dummy portion 500 may be formed on each of both the surfaces of the substrate 200 except for the region where the photosensitive material is disposed by using a plating method or the like. Here, the plating method may be the same as a known method. For example, a pattern or a panel seed may be disposed and the coil portion 300, the lead-out portion 400 and the dummy portion 500 may then be formed by using an electrolytic plating method. However, the present disclosure is not limited thereto.

In more detail, each of the coil portion 300, the lead-out portion 400 and the dummy portion 500 may be formed by using the electrolytic plating method for example, and is not limited thereto. A coil pattern 320 may be formed of a metal having excellent electrical conductivity, and may use, for example, silver (Ag), palladium (Pd), aluminum (Al), nickel (Ni), titanium (Ti), gold (Au), copper (Cu), platinum (Pt) or an alloy thereof.

A via may be formed by forming a via hole in a portion of the substrate 200 and then filling the via hole with a conductive material, and may electrically connect the coil portions 300 respectively formed on one surface and the other surface of the insulation substrate to each other.

The coil portion 300 may be connected to the lead-out portion 400 exposed to each of first and third side surfaces 100A and 100C of a body 100 after being diced. Respective both ends of adjacent coil portions 300 in a state of the coil bar before being diced may be physically and electrically connected to each other.

The dummy portion 500 may also be embedded in the body 100. The dummy portions 500 may be disposed at corners of the body 100, and form an X-shape.

In particular, the dummy portion 500 may have a width of 10 μm to 500 μm, and is not limited thereto. The dummy portion 500 having a width of less than 10 um may not function as a stopper when plated. The dummy portion 500 having a width of more than 500 μm may make the coil component have an excessively large size, and it is thus difficult to manufacture a thin/small coil component.

The following is a method of measuring the width of the dummy portion 500.

First taken is a cross section of any point of the dummy portion 500. Here, any point may correspond to a plurality of any points, and is not limited thereto.

Next, based on the cross section of the dummy portion 500, a length of the dummy portion in the first direction, that is, in a direction other than the thickness direction (hereinafter referred to as width of the dummy portion), may be measured several times. Here, the width of the dummy portion 500 may correspond to an arithmetic average of measured values obtained from the several measurements.

A thin film power inductor may be deformed when a magnetic layer is stacked on a printed circuit board and then compressed. Here, the printed circuit board may have an increased region for supporting the coil, which may be advantageous in the deformation and exposure of the coil, and is not limited thereto.

It is possible to make the coil component smaller and thinner and reduce a cut margin by minimizing the deformation or loss of the coil. It is thus possible to improve a characteristic of a coreless printed circuit board and a saturated current value (Isat) characteristic of the power inductor.

Next, disposed is an insulating layer 600 covering at least a portion of each of the substrate 200, the coil portion 300, the lead-out portion 400 and the dummy portion 500.

The insulating layer 600 may be formed by using a method such as a screen printing method, a spray application process, a vacuum dipping process, a vapor deposition method (CVD) or a film lamination method, and is not limited thereto.

Next, the coil bar may be formed by stacking a magnetic sheet covering each of the substrate 200, the coil portion 300, the lead-out portion 400 and the dummy portion 500.

The following is a specific method of forming the coil bar.

First performed is a trimming process of removing a portion of the substrate 200, in which the coil portion 300, the lead-out portion 400 or the dummy portion 500 is not formed.

The corresponding portion may be removed from the substrate 200 by using mechanical drilling, laser drilling, sand blasting, punching processing or the like, and may be removed by using a carbon dioxide (CO₂) laser drill for example.

In particular, a through hole passing through the insulation substrate may be formed by removing a central region of the insulation substrate, where the coil portion 300, the lead-out portion 400 or the dummy portion 500 is not formed.

Conventionally removed are all regions of the insulation substrate except for a region where the coil portion 300 is formed. However, in an exemplary embodiment of the present disclosure, it is possible not to remove one region of the substrate, where the coil portion 300 is not formed, to form a connection portion, thereby increasing a force to support the coil portion 300, which may minimize deformation of the coil portion 300 when stacking and compressing the magnetic composite sheet.

In addition, although not illustrated, the coil portion 300 may be a wound coil covered by an insulating film and formed by a winding method. Here, the coil portion 300 may be formed by forming a mold portion instead of the substrate, and the insulation substrate may be removed after forming a wound coil pattern using the substrate, and is not limited thereto. Here, a method of forming the wound coil pattern may be the same as a known method.

Next, the body 100 may be formed by stacking the magnetic sheet on the insulation substrate.

The body 100 may be formed by stacking magnetic sheet 20 on each of two sides of the insulation substrate and compressing the same by using a lamination method or a hydrostatic press method.

The magnetic sheet may be formed by molding a magnetic material-resin composite in a sheet shape, and may be compressed in a semi-cured state. The magnetic material-resin composite may be a mixture of magnetic metal powder particles and a resin mixture. Here, the magnetic metal powder particles may mainly include iron (Fe), chromium (Cr) or silicon (Si), and the resin mixture may include epoxy, polyimide, liquid crystal polymer (LCP) or a mixture thereof, and are not limited thereto. An empty space in a space processed by the compression of the first magnetic sheet 20 may be filled with a magnetic material such as the magnetic material-resin composite. When a curing process is performed as a subsequent process, it is possible to prevent the coil disposed at a predetermined position from being misaligned and to control deformation of the bar caused by movement of the sheet.

Here, the core portion may be formed when at least a portion of the magnetic sheet fills the through hole formed in the central region of the insulation substrate.

Finally diced are the insulation substrate and the magnetic sheet stacked on each of the two sides thereof along a boundary between the plurality of processed spaces, i.e., routing line. The dicing may be performed based on a size designed in advance, and as a result, the individual coil component 10A, 10B or 10C maybe provided. The individual coil component 10A, 10B or 10C may be provided when the dicing is performed using a dicing equipment or another dicing method such as a blade or a laser.

Meanwhile, the individual coil component 10A, 10B or 10C may include no insulation substrate and/or a fixing frame (not illustrated) after the dicing is performed when the substrate and/or the fixing frame (not illustrated) is designed to be smaller than a region (i.e., dicing-kerf region) that is cut off by a width of the dicing blade or the like. That is, the insulation substrate and/or the fixing frame (not illustrated) are for stably seating the coil, and may thus remain or may not remain in the final coil component. However, in order to improve accuracy in fixedly positioning the coil portion 300, some portions of the insulation substrate and/or the fixing frame (not illustrated) may remain in the coil portion 300 when the insulation substrate is significantly close to the coil portion 300.

Although not illustrated in the drawings, a polishing process may be performed to polish corners of the individual coil component 10A, 10B or 10C after the dicing process. The body 100 of the coil component 10A, 10B or 10C may be made into a round shape by the polishing process, and conventionally, an insulating material may be additionally printed on a surface of the body 100 to prevent its plating. The insulating layer formed here may include at least one of a glass-based material including silicon (Si), an insulating resin and plasma.

Next, the body 100 may be formed in a shape similar or identical to a hexahedral shape by applying a plating layer, an insulating portion 800 or the like to the individual coil component 10A, 10B or 10C.

In addition, the coil component 10A, 10B or 10C according to the present disclosure maybe formed by including first and second external electrodes 700A and 700B disposed on the first surface 101 of the body 100, while being spaced apart from each other, and each having at least a portion in contact with each of the substrate 200, the lead-out portion 400 and the dummy portion 500, and is not limited thereto.

Descriptions of the other components are substantially the same as those described above, and detailed descriptions thereof are thus omitted.

In the present specification, an expression that a component is disposed on another component is not intended to set a direction. Accordingly, the expression that the component is disposed on another component may indicate that the component is disposed on an upper side of another component, or disposed on a lower side of another component.

In the present specification, terms such as an upper surface, a lower surface, an upper side, a lower side, an uppermost side, a lowermost side and the like indicate directions set based on the drawings for convenience of description. Therefore, depending on the set directions, the upper surface, the lower surface, the upper side, the lower side, the uppermost side, the lowest side and the like may be described with different terms.

A meaning that a component is connected to another component herein conceptually includes not only a direct connection between two components but also their indirect connection through a third component. In addition, a term “electrically connected” conceptually includes a physical connection and a physical disconnection.

In the present specification, terms such as “first” and “second” are used to distinguish one component from another component, and do not limit a sequence, importance and the like of the corresponding components. In some cases, a first component may be named a second component and a second component may also be similarly named a first component, without departing from the scope of the present disclosure.

The term “an exemplary embodiment” used herein does not refer to the same exemplary embodiment, and is provided to emphasize a particular feature different from that of another exemplary embodiment. However, exemplary embodiments provided herein may be implemented by being combined in whole or in part one with one another. For example, one element described in a particular exemplary embodiment may be understood as a description related to another exemplary embodiment even if it is not described in another exemplary embodiment, unless an opposite or contradictory description is provided therein.

Terms used herein are used only in order to describe an exemplary embodiment rather than limiting the present disclosure. In this case, singular forms include plural forms unless interpreted otherwise in context.

As set forth above, according to the exemplary embodiments of the present disclosure, it is possible to provide the coil component which may be mounted on the board including the microcircuit pattern.

According to the exemplary embodiments of the present disclosure, it is also possible to provide the coil component including the coil with less deformation.

While exemplary embodiments have been shown and described above, it will be apparent to those skilled in the art that modifications and variations could be made without departing from the scope of the present disclosure as defined by the appended claims.

What is claimed is:

1. A coil component comprising:
a body including a first surface and first to fourth side surfaces respectively connected to the first surface;
a substrate disposed in the body;
a coil portion disposed on the substrate;
a lead-out portion disposed in the body and connected to the coil portion; and
a dummy portion spaced apart from the lead-out portion,
wherein the body includes four corners, at each of which two adjacent side surfaces of the first to fourth side surfaces are in contact with each other, and
the dummy portion includes first to fourth dummy patterns respectively disposed outside the coil portion and extending toward the four corners of the body.

2. The coil component of claim 1, wherein the substrate supports each of the coil portion and the dummy portion.

3. The coil component of claim 2, wherein a portion of the substrate supporting the coil portion and a portion of the substrate supporting the dummy portion are integrally formed with each other.

4. The coil component of claim 3, wherein the dummy portion is spaced apart from the coil portion.

5. The coil component of claim 3, further comprising an external electrode disposed on each of the first and third side surfaces of the body, opposing each other,
wherein the external electrode is insulated from the dummy portion.

6. The coil component of claim 1, wherein at least a portion of the lead-out portion extends to each of the first and third side surfaces of the body, opposing each other.

7. The coil component of claim 1, wherein the dummy portion is spaced apart from the coil portion.

8. The coil component of claim 7, further comprising an external electrode disposed on each of the first and third side surfaces of the body, opposing each other,
wherein the external electrode is insulated from the dummy portion.

9. The coil component of claim 7, wherein at least a portion of the substrate is exposed to a space where the dummy portion and the coil portion are spaced apart from each other.

10. The coil component of claim 1, further comprising an insulating layer covering at least a portion of the coil portion.

11. The coil component of claim 10, wherein at least a portion of the insulating layer extends to each of the substrate and the dummy portion.

12. The coil component of claim 1, further comprising an external electrode having first and second external electrodes disposed on the first surface of the body, while being spaced apart from each other.

13. The coil component of claim 12, wherein the external electrode is disposed on each of the first and third side surfaces of the body, opposing each other, and is in contact with at least a portion of the lead-out portion.

14. The coil component of claim 12, wherein the external electrode is insulated from the dummy portion.

15. The coil component of claim 1, wherein the external electrode is in contact with at least a portion of the dummy portion.

16. A manufacturing method of a coil component, the method comprising:
preparing a substrate supporting each of a dummy portion, a coil portion and a lead-out portion;
forming a coil bar by stacking a magnetic sheet covering each of the dummy portion, the coil portion and the lead-out portion; and
preparing a body including a first surface and a second surface opposing each other in a thickness direction by routing the coil bar along a routing line to expose at least a portion of the lead-out portion,
wherein the dummy portion includes first to fourth dummy patterns respectively disposed outside the coil portion and extending toward the four corners of the body, and
the dummy portion and the lead-out portion are spaced apart from each other.

17. A coil component comprising:
a body;
a substrate disposed in the body;
a coil portion disposed on the substrate;
a lead-out portion disposed in the body and connected to the coil portion; and
a dummy portion disposed in the body and including first to fourth dummy patterns each being spaced apart from the coil portion.

18. The coil component of claim 17, wherein the body includes a first surface and first to fourth side surfaces respectively connected to the first surface,
the body further includes four corners, at each of which two adjacent side surfaces of the first to fourth side surfaces are in contact with each other,
each of the first to fourth dummy patterns extends toward a respective one of the four corners in a diagonal direction.

19. The coil component of claim 18, wherein each of the first to fourth dummy patterns extends to be in contact with two adjacent side surfaces among the first to fourth side surfaces.

20. The coil component of claim 19, further comprising first and second external electrodes respectively disposed on the first and third side surfaces of the body, opposing each other, and connected to the lead-out portion, and
at least a portion of each of the first to fourth dummy patterns is in contact with the first external electrode or the second external electrode.
